(19) United States
(12) Patent Application Publication
(10) Pub. No.: US 2008/0005291 A1
(43) Pub. Date: Jan. 3, 2008

(54) COORDINATED INFORMATION DISPERSION IN A DISTRIBUTED COMPUTING SYSTEM

(75) Inventors: Myung M. Bae, Pleasant Valley, NY (US); Jifang Zhang, Poughkeepsie, NY (US)

Correspondence Address: FLEIT, KAIN, GIBBONS, GUTMAN,;BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 11/421,591

(22) Filed: Jun. 1, 2006

(51) Int. Cl. G06F 15/173

(52) U.S. Cl. 709/223

(57) ABSTRACT

A method for dispersing scattered information in a coordinated fashion in a distributed computing system having a plurality of nodes where at least two of the nodes are members of a group. The method includes receiving a proposal for a protocol from one of the nodes and sending a request to at least one member of the group of nodes for additional proposals. The method also includes receiving at least one additional proposal in response to the request and sending the proposal and the at least one additional proposal to members of the group at substantially the same time.

### FIELD OF THE INVENTION

This invention relates in general to the application of distributed computing system environments, and in particular to efficiently dispersing scattered information in a coordinated fashion.

### BACKGROUND OF THE INVENTION

The present invention is generally directed to scattering and gathering information among group members of one or more groups in a single system or a cluster system or cluster systems, such as in a multi-node computer system, and its application to a number of such environments including Group Services.

A group is an abstract collection of specific entities like network adapters, cluster nodes, or distributed application processes in a clustered system. For example, an Ethernet adapter group represents a set of all Ethernet adapters in a cluster, and a cluster-aware application “X” is a set of processes of the application “X” in a cluster.

The membership of the group refers to a set of each element in a group. A membership of an Ethernet adapter group may be a list of IP addresses that are in the cluster. Typically an active (or current) membership refers to the members that are active in a cluster (e.g., running, reachable, etc). In other words, if a member is in the active membership, it is considered as working, active, reachable, or detectable in the cluster. If not, the member is considered as down, inactive, unreachable, or undetectable.

Many cluster-aware applications attempt to join one or more groups to coordinate the actions among the group members, and decide the next action based on the member states or by exchanging messages. If a new client wants to join a group, the existing members will participate in the voting process to decide whether or not to let the client join. During the execution of the join protocol, each member of the group will give a vote whether the join request should be allowed or not. Even if most of the members approve the request, the join request may be rejected or be continued if one of the members rejects, or asks to continue to the next round. In these cases, the current Group Services agreement process requires multiple rounds of consensus until every member broadcasts its necessary information to all nodes. For example, HACMP or PeerDomain daemons (e.g., VSDRM) may need to exchange many rounds of Group Services protocols before they are fully considered as the working members in the cluster.

In each step, one of the nodes sends the necessary proposal information or voting value to all and then the other nodes make the decision whether the proposal is acceptable or not. If it is accepted, then the next node performs another protocol by doing the same thing until all nodes exercise such agreement.

In some cases, the decision whether to approve, reject, or continue may need to be based on all other's information, not just based on each member's own local information. This implies that all group members need to send their information to all other members.

There may also be situations where several members of a group may want to distribute some messages to all others in an efficient manner rather than broadcasting them in many phases. In addition, each member of a group may want to make a decision based on the each member's state of aliveness during the protocol execution.

For instance, a group has three members p1, p2, and p3. p1 has information m1, p2 has information m2, and P3 has information m3. Generally, it takes as many steps as there are members that have information to share. Referring now to FIGS. 8a and 8b, it can be seen that at least three steps are required to reach total agreement.

In step 802 of FIG. 8a, provider (or member) p1 proposes the information m1. Group Services proposes the protocol to the group members in step 804. On the receipt of the protocol proposal, each member votes on the proposed information in step 806. A check is performed to determine if all members agree on the proposed protocol in step 808. If all members agree on the proposal, the proposal will be accepted in Group Services in step 812 and the process moves on to the next proposal in step 814. If, however, it is determined in step 808 that the proposal is not accepted, some other action is performed in step 810. The other action is not relevant here and will, therefore, not be explained in any further detail.

In step 814 a provider (or member) p2 proposes the information m2. Group Services proposes the protocol to the group members in step 816. Just as in the previous stage, in step 818, on the receipt of the protocol proposal, each member votes on the proposed information. A check is performed to determine if all members agree on the proposed protocol in step 820. Just as in the previous stage, if all members agree on the proposal, the proposal will be accepted in Group Services in step 822 and the process moves on the next proposal in step 824. If, however, it is determined in step 820 that the proposal is not accepted, some other action is performed in step 810.

Finally, in step 824 a third provider (or member) p3 proposes the information m3. Group Services proposes the protocol to the group members in step 826. Just as in the previous stage, in step 828, on the receipt of the protocol proposal, each member votes on the proposed information. A check is performed to determine if all members agree on the proposed protocol in step 830. Just as in the previous two stages, if all members agree on the proposal, the proposal will be accepted in Group Services in step 832. If, however, it is determined in step 820 that the proposal is not accepted, some other action is performed in step 810. The process ends in step 834.

FIG. 8b graphically shows the process just described with reference to FIG. 8a. FIG. 8b clearly shows that a stage is needed for each node to propose its respective protocol.

Not only is the proposal process time consuming, the probability of failures increases and thus overall cluster stability may be dampened. Thus, what is needed is an improved system and method that provides an efficient method to gather and scatter the distributed information from and to all other members.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings in which:

FIG. 1 depicts a distributed computing environment incorporating the principles of one embodiment of the present invention.

FIG. 2 depicts an expanded view of a number of the processing nodes of the distributed computing environment of FIG. 1 in accordance with one embodiment of the present invention.

FIG. 3 depicts the components of a Group Services facility in accordance with one embodiment of the present invention.

FIG. 4 illustrates a processor group in accordance with one embodiment of the present invention.

FIG. 5a depicts a process for recovering from a failed group leader of the processor group of FIG. 4 in accordance with one embodiment of the present invention.

FIG. 5b depicts another process for recovering from a failed group leader of the processor group of FIG. 4 in accordance with one embodiment of the present invention.

FIG. 6a illustrates an exemplary group leader in accordance with one embodiment of the present invention.

FIG. 6b illustrates a technique for selecting a new group leader when the current group leader fails in accordance with one embodiment of the present invention.

FIG. 7 depicts a name server receiving information from a group leader in accordance with one embodiment of the present invention.

FIG. 8a is a process flow diagram illustrating an n-step voting process for n nodes.

FIG. 8b is a block diagram illustrating the process flow of FIG. 8a.

FIG. 9a is a process flow diagram illustrating a single-step voting process in accordance with one embodiment of the present invention.

FIG. 9b is a block diagram illustrating the process flow of FIG. 9b.

FIG. 10 is a hardware block diagram illustrating one embodiment of a computer system that is useful for implementing embodiments of the present invention.

### DETAILED DESCRIPTION OF THE INVENTION

Embodiments of the present invention provide efficient systems and methods for gathering and scattering distributed information from and to members of a distributed computing system. The system and method provide a reduced number of protocol executions to reach total agreement on personalized/scattered proposals, even when each member of the group has a different opinion (or information). Embodiments of the present invention therefore advantageously reduce the probability of failures during the total agreement processing.

Group Services Operation

Group Services is a system-wide service that provides a facility for coordinating, managing and monitoring changes to a subsystem running on one or more processors of a distributed computing environment. A more detailed description of Group Services may be found in U.S. Pat. No. 6,216,150 to Badovinatz et al., which is herein incorporated by reference. Group Services provides an integrated framework for designing and implementing fault-tolerant subsystems and for providing consistent recovery of multiple subsystems. Group Services offers a simple programming model based on a small number of core concepts. These concepts include, in some embodiments of the present invention, a cluster-wide process group membership and synchronization service that maintains application specific information with each process group.

As described above, in some emodiments, the mechanisms of the present invention are included in a Group Services facility. However, the mechanisms of the present invention can be used in or with various other facilities, and thus, Group Services is only one example. The use of the term Group Services to include the techniques of the present invention is for illustration only.

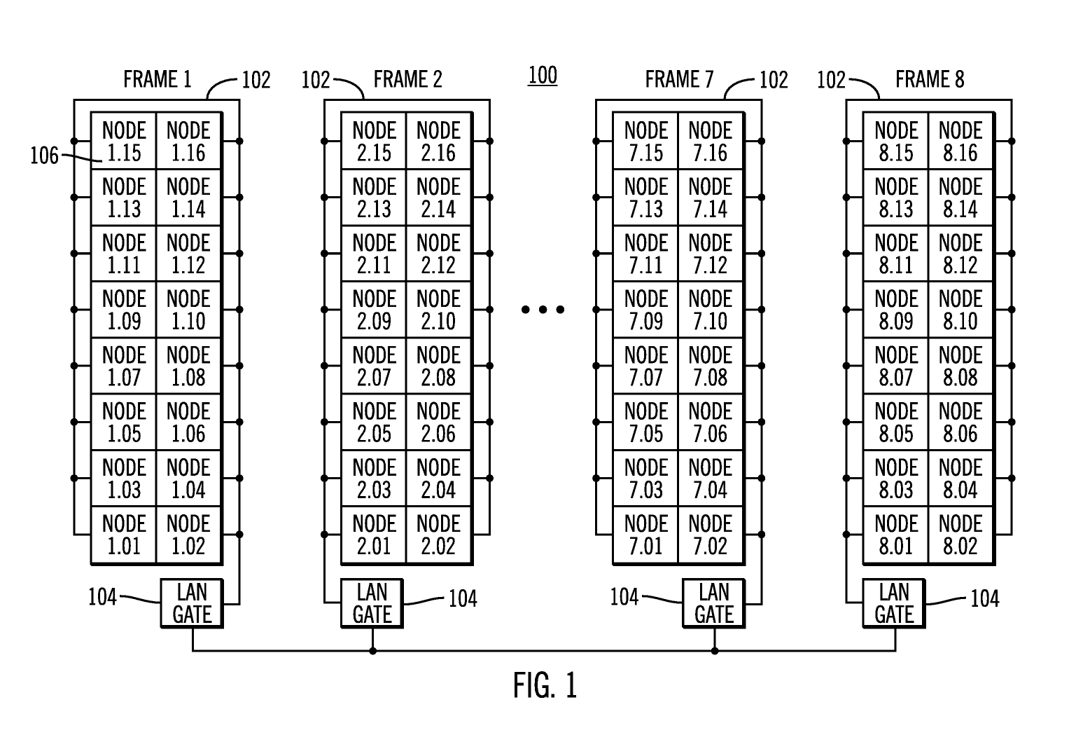

In one embodiment, the mechanisms of the present invention are incorporated and used in a distributed computing environment, as shown in FIG. 1. In this example, distributed computing environment 100 includes a plurality of frames 102 coupled to one another via a plurality of LAN gates 104. Frames 102 and LAN gates 104 are described in detail below.

In this example, distributed computing environment 100 includes eight (8) frames, each of which includes a plurality of processing nodes 106. In this instance, each frame includes sixteen (16) processing nodes (or processors). Each processing node is, for instance, a RISC/6000 computer running AIX, a UNIX based operating system. Each processing node within a frame is coupled to the other processing nodes of the frame via an internal LAN connection. Additionally, each frame is coupled to the other frames via LAN gates 104.

As examples, each LAN gate 104 includes either a RISC/6000 computer, any computer network connection to the LAN, or a network router. However, these are only examples. Other types of LAN gates and other mechanisms can also be used to couple the frames to one another.

Further embodiments have more or less than eight frames, or more or less than sixteen nodes per frame. Further, the processing nodes do not have to be RISC/6000 computers running AIX. Some or all of the processing nodes can include different types of computers and/or different operating systems.

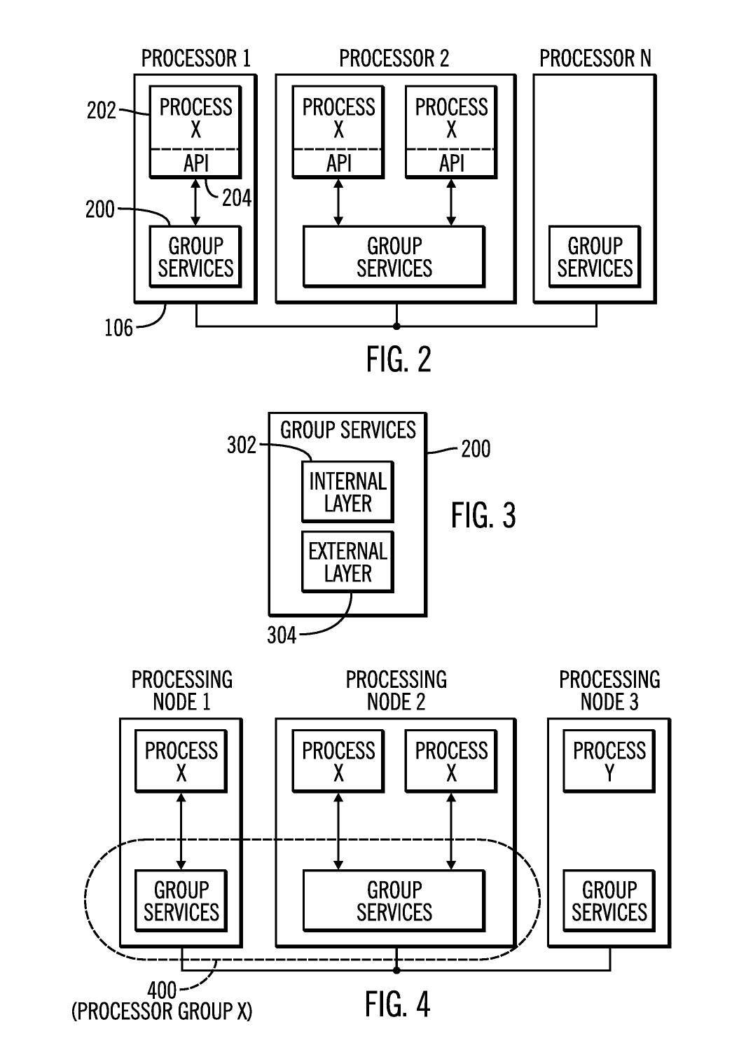

In this exemplary embodiment, a Group Services subsystem incorporating the mechanisms of the present invention is distributed across a plurality of the processing nodes of distributed computing environment 100. In particular, in this example, a Group Services daemon 200 (FIG. 2) is located within one or more of the processing nodes 106. The Group Services daemons are collectively referred to as Group Services.

Group Services facilitates, for instance, communication and synchronization between multiple processes of a process group, and can be used in a variety of situations, including providing a distributed recovery synchronization mechanism. A process 202 (FIG. 2) desirous of using the facilities of Group Services is coupled to a Group Services daemon 200. In particular, the process is coupled to Group Services by linking at least a part of the code associated with Group Services (e.g., the library code) into its own code. This linkage enables the process to use the mechanisms of the present invention, as described in detail below.

In this exemplary embodiment, a process uses the mechanisms of the present invention via an application programming interface 204. In particular, the application programming interface provides an interface for the process to use the mechanisms of the present invention, which are included in Group Services. In this embodiment, Group Services 200 includes an internal layer 302 (FIG. 3) and an external layer 304, each of which is described in detail below.

Internal layer 302 provides a limited set of functions for external layer 304. The limited set of functions of the internal layer can be used to build a richer and broader set of functions, which are implemented by the external layer and exported to the processes via the application programming interface. The internal layer of Group Services (also referred to as a metagroup layer) is concerned with the Group Services daemons, and not the processes (i.e., the client processes) coupled to the daemons. That is, the internal layer focuses its efforts on the processors, which include the daemons. In this example, there is only one Group Services daemon on a processing node; however, a subset or all of the processing nodes within the distributed computing environment can include Group Services daemons.

The internal layer of Group Services implements functions on a per processor group basis. There may be a plurality of processor groups in the network. Each processor group (also, referred to as a metagroup) includes one or more processors having a Group Services daemon executing thereon. The processors of a particular group are related in that they are executing related processes. (In one example, processes that are related provide a common function.) For example, referring to FIG. 4, a Processor Group X (400) includes Processing Node 1 and Processing Node 2, since each of these nodes is executing a process X, but it does not include Processing Node 3. Thus, Processing Nodes 1 and 2 are members of Processor Group X. A processing node can be a member of none or any number of processor groups, and processor groups can have one or more members in common.

In order to become a member of a processor group, a processor needs to request to be a member of that group. A processor requests to become a member of a particular processor group (e.g., Processor Group X) when a process related to that group (e.g., Process X) requests to join a corresponding process group (e.g., Process Group X) and the processor is not aware of that corresponding process group. Since the Group Services daemon on the processor handling the request to join a particular process group is not aware of the process group, it knows that it is not a member of the corresponding processor group. Thus, the processor asks to become a member, so that the process can become a member of the process group. (A technique for becoming a member of a processor group is described in detail further below.) Internal layer 302 (FIG. 3) implements a number of functions on a per processor group basis. These functions include, for example, maintenance of group leaders, insert, multicast, leave, and fail, each of which is described in detail below.

In this embodiment of the present invention, a group leader is selected for each processor group of the network. In one example, the group leader is the first processor requesting to join a particular group. The group leader is responsible for controlling activities associated with its processor group(s). For example, if processing node Node 2 (FIG. 4) is the first node to request to join Processor Group X, then Processing Node 2 is the group leader and is responsible for managing the activities of Processor Group X. It is possible for Processing Node 2 to be the group leader of multiple processor groups.

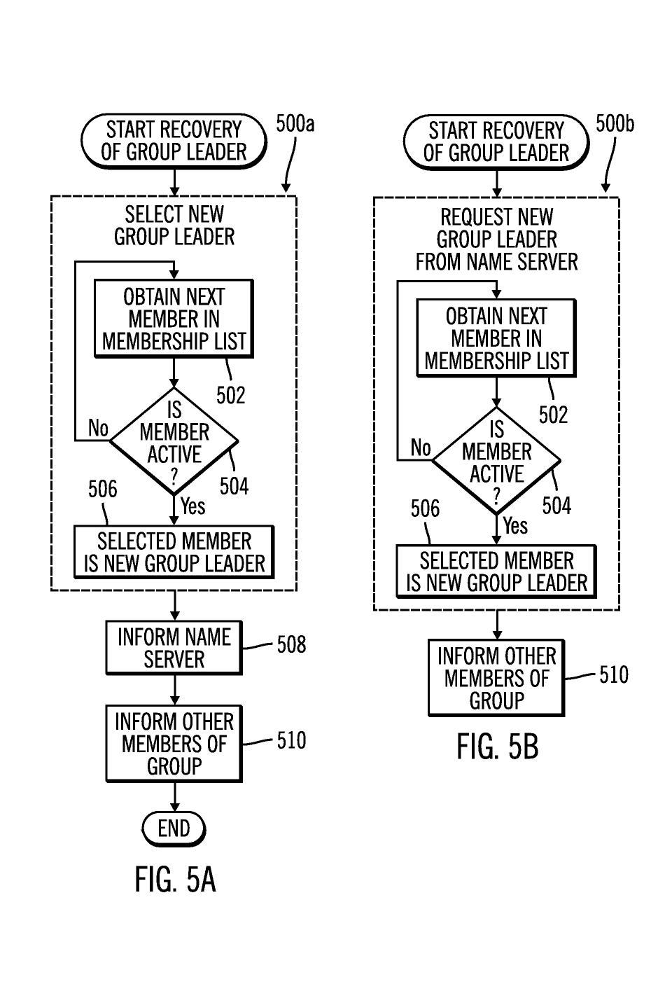

If the group leader is removed from the processor group for any reason, including the processor requests to leave the group, the processor fails or the Group Services daemon on the processor fails, then group leader recovery takes place. In particular, a new group leader is selected, as shown in FIG. 5A.

In this example, in order to select a new group leader, a membership list for the processor group, which is ordered in sequence of processors joining the group, is scanned, by one or more processors of the group, for the next processor in the list, in STEP 502. Thereafter, a determination is made as to whether the processor obtained from the list is active in step 504. In this exemplary embodiment, this is determined by another subsystem distributed across the processing nodes of the distributed computing environment. The subsystem sends a signal to at least the nodes in the membership list, and if there is no response from a particular node, it assumes the node is inactive.

If the selected processor is not active, then the membership list is scanned again until an active member is located. When an active processor is obtained from the list, this processor is the new group leader for the processor group, in STEP 506.

For example, assume that three processing nodes joined Processor Group X in the following order:

Processor 2, Processor 1, and Processor 3.

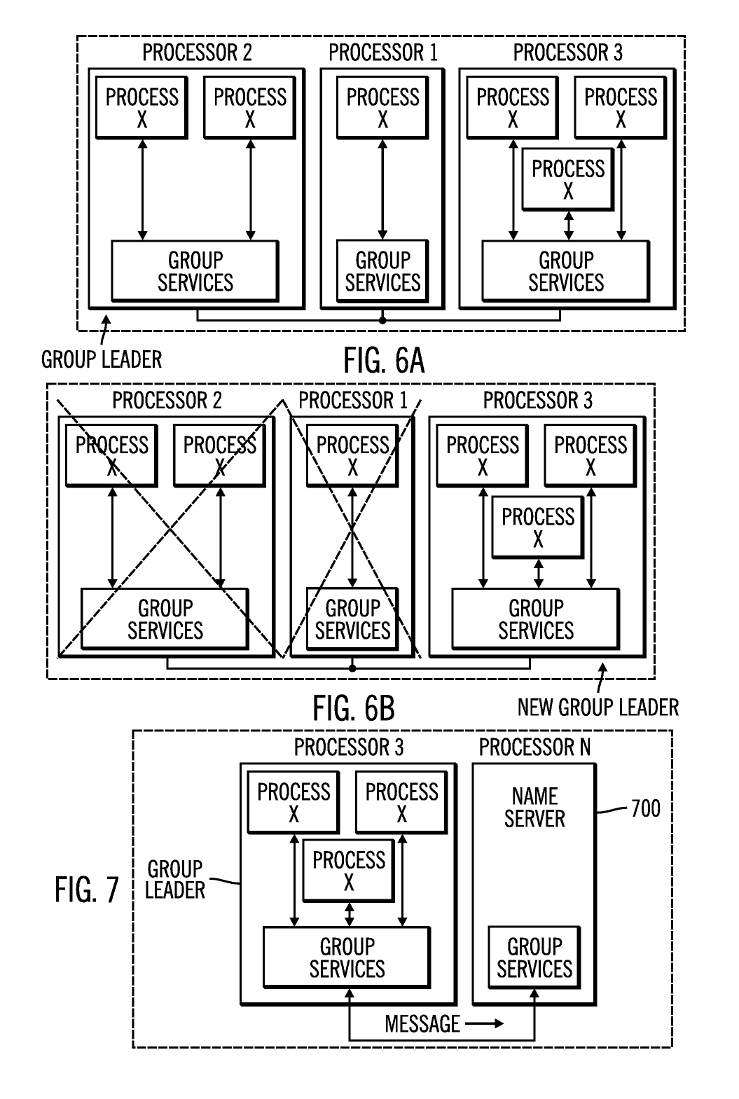

Thus, Processor 2 is the initial group leader (see FIG. 6A). At some time later, Processor 2 leaves Processor Group X, and therefore, a new group leader is desired. According to the membership list for Processor Group X, Processor 1 is the next group leader. However, if Processor 1 is inactive, then Processor 3 would be chosen to be the new group leader (FIG. 6b).

In this example, the membership list is stored in memory of each of the processing nodes of the processor group. Thus, in the above example, Processor 1, Processor 2, and Processor 3 would all contain a copy of the membership list. In particular, each processor to join the group receives a copy of the membership list from the current group leader. In another example, each processor to join the group receives the membership list from another member of the group other than the current group leader.

Referring back to FIG. 5a, in this embodiment of the invention, once the new group leader is selected, the new group leader informs a name server that it is the new group leader in STEP 508. As one example, a name server 700 (FIG. 7) is one of the processing nodes within the distributed computing environment designated to be the name server. The name server serves as a central location for storing certain information, including a list of all of the processor groups of the network and a list of the current group leaders for all of the processor groups. This information is stored in the memory of the name server processing node. The name server can be a processing node within the processor group or a processing node independent of the processor group.

In this example, name server 700 is informed of the group leader change via a message sent from the Group Services daemon of the new group leader to the name server. Thereafter, the name server then informs the other processors of the group of the new group leader via, for example, an atomic multicast, in STEP 510. Multicasting is similar in function to broadcasting, however, in multicasting the message is directed to a selected group, instead of being provided to all processors of a system. In this example, multicasting can be performed by providing software that takes the message and the list of intended recipients and performs point to point messaging to each intended recipient using, for example, a User Datagram Protocol (UDP) or a Transmission Control Protocol (TCP). In another embodiment, the message and list of intended recipients are passed to the underlying hardware communications, such as Ethernet, which will provide the multicasting function.) In another embodiment of the invention, a member of the group other than the new group leader informs the name server of the identity of the new group leader. As a further example, the processors of the group are not explicitly informed of the new group leader, since each processor in the processor group has the membership list and has determined for itself the new group leader.

In another embodiment of the invention, when a new group leader is needed, a request is sent to the name server requesting from the name server the identity of the new group leader, as shown in FIG. 5B. In this embodiment, the membership list is also located at the name server, and the name server goes through the same steps described above for determining the new group leader, that is STEPS 502, 504 and 506. Once it is determined, the name server informs the other processors of the processor group of the new group leader, in STEP 510. In addition to the group leader maintenance function implemented by the internal or metagroup layer, an insert function is also implemented. The insert function is used when a Group Services daemon (i.e., a processor executing the Group Services daemon) wishes to join a particular group of processors.

In one embodiment of the present invention, the single, unified framework is provided to members of process groups. A process group includes one or more related processes executing on one or more processing nodes of the distributed computing environment. For example, referring to FIG. 4, a Process Group X (400) includes a Process X executing on Processor 1 and two Process X's executing on Processor 2. As described above, a processor requests to be added to a particular processor group when a process executing on the processor wishes to join a process group and the processor is unaware of the process group. The manner in which a process becomes a member of a particular process group or shares information among a group is described in detail below.

There are situations in which several members of a group wish to distribute some messages to all other members in an efficient manner rather than broadcasting them in several phases, as is done with current systems. In addition to information exchanges, in some cases, each member of a group may want to make a decision based on the each member's state of aliveness during the protocol execution.

Embodiments of the present invention provide a system and method for distributing (scattering) and gathering each member of a group's information in each phase of a protocol, regardless of whether it is in join protocol, leave protocol, change state protocol, or any n-phase group protocol for a single system, cluster system, or cluster systems. The proposed information can be each state value, any message, or aliveness state.

One embodiment of the present invention gathers voting information and other information from members by saving and refreshing each voter vote value, state value, member message, or failure reason in each voting phase of a protocol. When a client initiates an n-phase protocol, such as a join protocol, instead of sending the information to all of the members and initiating a vote, the group sends a callback to the existing members of the group to ask if they have information to submit. Each member will submit their information, which will be stored in memory on the system, and simultaneously request a vote value, such as approve, or reject, or continue (which means go to the next round voting phase). The voter can also include a state value, a message, a failure reason, or others, and the group can save these vote values, state values, and messages. If the group finds that a member left the group or does not give the vote in time, it will collect the failure reason. After all of the expected information is obtained, a callback is invoked to send the information to the voters in the next round of the protocol.

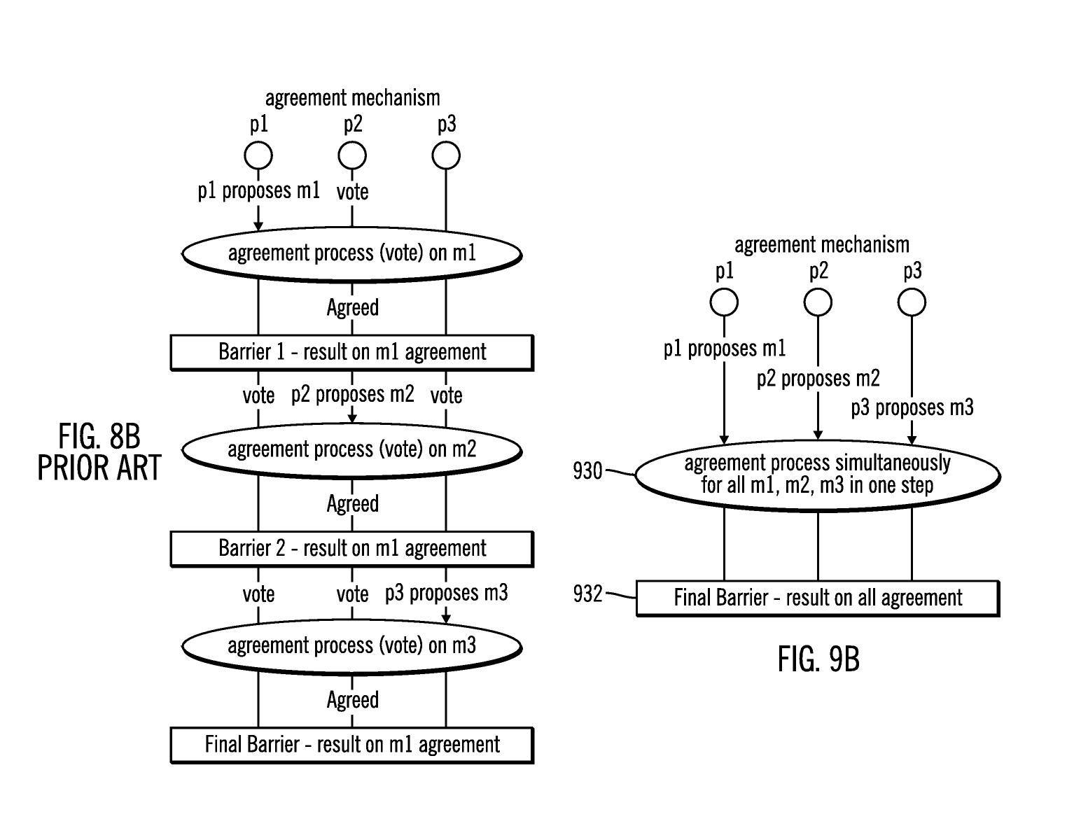

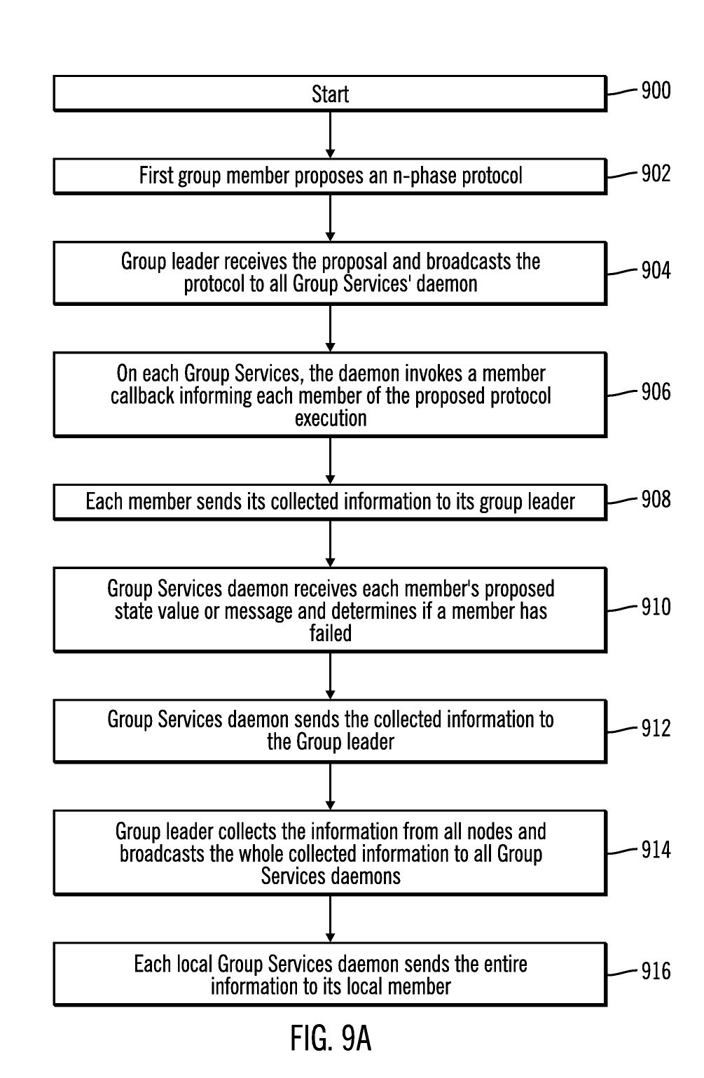

FIG. 9a is a flow diagram of an embodiment of the present invention. A group has three members, p1, p2, and p3. The flow begins at step 900 and flows directly to step 902, where a first group member, p1, proposes an n-phase protocol. An example of such an n-phase protocol is a join protocol, which needs to exchange information among all nodes. In step 904, the group leader receives the proposal and broadcasts the protocol to all Group Services' daemons. In each Group Services, in step 906, the daemon invokes a member callback informing each member of the proposed protocol execution. This notification acts as a prompt to each member to vote on the proposal and to also, substantially simultaneously, send any information that it has so that the other members can vote on that further information, which may be additional proposals. To exchange all information, each member sends its collected information to its group leader in step 908. In step 910, each member sends its proposed state value or message to the local Group Services daemon. A check is also made during step 910 to determine if a member has failed. This failure, and its reason, is detected by the local Group Services daemon. After the collection of the information from each member, or the detection of the failure, the local Group Services daemon sends the collected information to the Group leader in step 912. The Group leader collects the information from all nodes, in step 914, and broadcasts the whole collected information to all Group Services daemons again. Then, in step 916, each local Group Services daemon sends the entire information to its local member.

By performing this procedure, all information can be collected and rebroadcast in one protocol phase instead of multiple protocol phases.

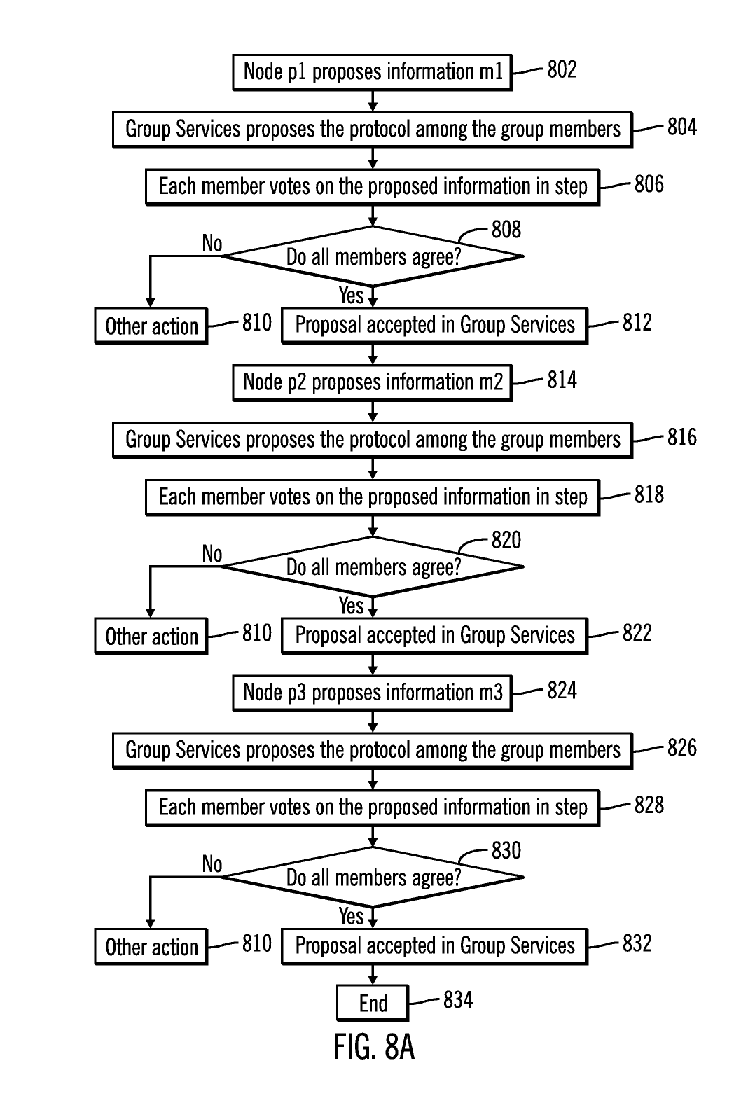

FIG. 9b shows the reduced steps of this embodiment of the present invention, as compared to FIG. 8b. In FIG. 9b, all members, p1, p2, and p3, submit information. A single vote process 930 is performed, which results in a total agreement 932. A vote can be any type of decision indication or computer processor assisted method for reaching a result. Voting processes on distributed nodes in a distributed computer environment are well known.

The above-described protocol can also be integrated with process group membership and process group state values. In particular, the mechanisms of the embodiment of the present invention described above are used to manage and monitor membership and states changes to the process groups. Changes to group membership are proposed via the protocol described above. Additionally, these mechanisms mediate changes to the group state value, and guarantee that it remains consistent and reliable, as long as at least one process group member remains.

The present invention can be realized in hardware, software, or a combination of hardware and software. A system according to an embodiment of the present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general-purpose computer system with a computer program that, when being loaded and executed, controls the computer system such that it carries out the methods described herein.

An embodiment of the present invention can also be embedded in a computer program product which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

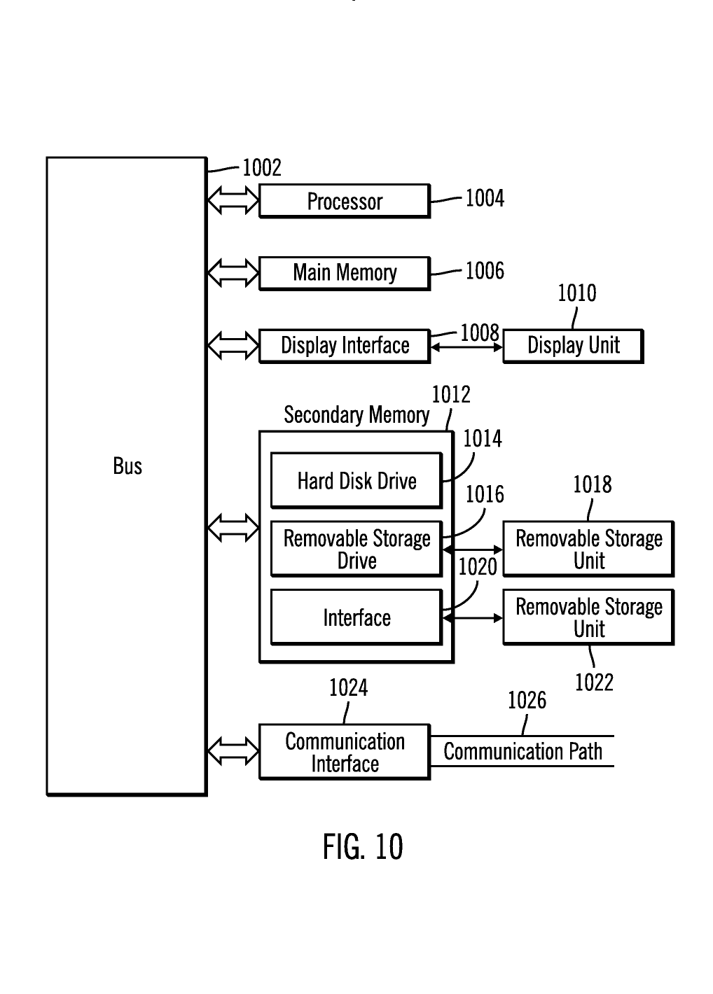

FIG. 10 is a block diagram of a computer system useful for implementing an embodiment of the present invention. The computer system includes one or more processors, such as processor 1004. The processor 1004 is connected to a communication infrastructure 1002 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 1008 that forwards graphics, text, and other data from the communication infrastructure 1002 (or from a frame buffer not shown) for display on the display unit 1010. The computer system also includes a main memory 1006, preferably random access memory (RAM), and may also include a secondary memory 1012. The secondary memory 1012 may include, for example, a hard disk drive 1014 and/or a removable storage drive 1016, representing a floppy disk drive, a magnetic tape drive, an optical disk drive, etc. Removable storage drive 1016, reads and writes to a floppy disk, magnetic tape, optical disk, etc., storing computer software and/or data. The system also includes a resource table 1018, for managing resources R1-Rn such as disk drives, disk arrays, tape drives, CPUs, memory, wired and wireless communication interfaces, displays and display interfaces, including all resources shown in FIG. 10, as well as any others.

In alternative embodiments, the secondary memory 1012 includes other similar means for allowing computer programs or other instructions to be loaded into the computer system. Such means may include, for example, a removable storage unit 1022 and an interface 1020. Examples of such may include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to the computer system.

The computer system may also include a communications interface 1024. Communications interface 1024 allows software and data to be transferred between the computer system and external devices. The communication interface 1024 acts as a sender for sending data or other information and as a receiver for receiving information. Examples of communications interface 1024 may include a modem, a network interface (such as an Ethernet card), a communications port, a PCMCIA slot and card, etc. Software and data transferred via communications interface 1024 are in the form of signals which may be, for example, electronic, electromagnetic, optical, or other signals capable of being received by communications interface 1024. These signals are provided to communications interface 1024 via a communications path (i.e., channel) 1026. This channel 1026 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 1006 and secondary memory 1012, removable storage drive 1016, a hard disk installed in hard disk drive 1014, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 1106 and/or secondary memory 1012. Computer programs may also be received via communications interface 1024. Such computer programs, when executed, enable the computer system to perform the features of the present invention as discussed herein. In particular, the computer programs, when executed, enable the processor 1004 to perform the features of the computer system. Accordingly, such computer programs represent controllers of the computer system.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for dispersing scattered information in a coordinated fashion in a distributed computing system having a plurality of nodes with at least two of the nodes being members of a group, the method comprising the steps of:
receiving a proposal for a protocol from one of the nodes;
sending a request to at least one member of the group of nodes for additional proposals, the one member of the group of nodes being a different node than the node that sent the proposal;
receiving at least one additional proposal in response to the request; and
sending the proposal and the at least one additional proposal to members of the group at substantially the same time.

2. The method according to claim 1, further comprising the step of:
receiving a response to the proposal or the at least one additional proposal from one of the members of the group.

3. The method according to claim 2, wherein:
the response is an approval or a rejection.

4. The method according to claim 2, wherein the response includes a state value or a failure reason.

5. The method according to claim 1, wherein the protocol is a join protocol.

6. The method according to claim 1, further comprising the step of:
sending a request to all of the members of the group for additional proposals.

7. The method according to claim 1, further comprising the step of:
sending a request to all of the members of the group to vote on the proposal and the at least one additional proposal.

8. A computer readable medium containing a program for dispersing scattered information in a coordinated fashion, the program comprising instructions for:
receiving a proposal for a protocol from one of the nodes;
sending a request to at least one member of the group of nodes for additional proposals, the one member of the group of nodes being a different node than the node that sent the proposal;
receiving at least one additional proposal in response to the request; and
sending the proposal and the at least one additional proposal to members of the group at substantially the same time.

9. The computer readable medium according to claim 8, further comprising the step of:
receiving a response to the proposal or the at least one additional proposal from one of the members of the group.

10. The computer readable medium according to claim 9, wherein:
the response is an approval or a rejection.

11. The computer readable medium according to claim 9, wherein the response includes:
a state value or a failure reason.

12. The computer readable medium according to claim 8, wherein the protocol is a join protocol.

13. The computer readable medium according to claim 8, further comprising the step of:
sending a request to all of the members of the group for additional proposals.

14. The computer readable medium according to claim 8, further comprising the step of:
sending a request to all of the members of the group to vote on the proposal and the at least one additional proposal.

15. A group services daemon for execution in a distributed computing system having a plurality of nodes, the group services daemon comprising:
a receiver adapted for receiving a proposal for a protocol from one of the nodes; and
a transmitter adapted for sending a request to at least one member of the group of nodes for additional proposals, the one member of the group of nodes being a different node than the node that sent the proposal,
wherein the receiver receives at least one additional proposal in response to the request, and the transmitter sends the proposal and the at least one additional proposals to members of the group at substantially the same time.

16. The group services daemon according to claim 15, wherein:
the receiver receives a response to the proposal or the at least one additional proposal from at least one of the members of the group.

17. The group services daemon according to claim 15, wherein:
the response is an approval or a rejection.

18. The group services daemon according to claim 17, wherein the response includes a state value or a failure reason.

19. The group services daemon according to claim 15, wherein the protocol is a join protocol.

20. The group services daemon according to claim 15, further comprising the step of:
sending a request to all members of the group for additional proposals.
